(19) United States
(12) Patent Application Publication
(10) Pub. No.: US 2022/0399009 A1
(43) Pub. Date: Dec. 15, 2022

(54) PROTECTING SENSITIVE INFORMATION IN CONVERSATIONAL EXCHANGES

(71) Applicant: INTERNATIONAL BUSINESS MACHINES CORPORATION, ARMONK, NY (US)

(72) Inventors: Masakuni Okada, Abiko-shi (JP); Taku Sasaki, Machida-shi (JP); Seiya Shimizu, Yokohama-shi (JP)

(21) Appl. No.: 17/303,851

(22) Filed: Jun. 9, 2021

(51) Int. Cl. G10L 15/18; G10L 15/22; G06N 20/00; G06F 16/901; G06F 16/9038

(52) U.S. Cl. CPC G10L 15/1815; G10L 15/1822; G10L 15/22; G06N 20/00; G06F 16/9027; G06F 16/9038; G10L 2015/088

(57) ABSTRACT

A computer-implemented method, a computer system and a computer program product analyze conversations. The method includes capturing a conversation with a microphone. The conversation comprises a plurality of utterances. The method also includes converting the plurality of utterances into text data using speech recognition algorithms. A speaker is identified and associated for each of the plurality of utterances. The method further includes determining an intent of the conversation. In addition, the method includes, for each determined intent, classifying each of the plurality of utterances based on the associated speaker and a set of categories associated with each of the plurality of utterances. The method also includes determining whether each of the plurality of utterances includes information sensitive to the associated speaker. Finally, the method includes storing the utterance in response to an utterance within the plurality of utterances not including information sensitive to the associated speaker.

### BACKGROUND

Embodiments relate generally to voice recognition of secure communications and, specifically, to monitoring audio conversations for the purpose of providing advanced services to users while also maintaining a security filter to prevent the storing or dissemination of sensitive information within the conversation.

Voice-enabled devices may be used to capture conversations that occur nearby, from which information may be used in an edge computing environment to enable advanced services for users. Information security may be increasingly important for protecting confidential corporate, as well as personal, communication from unintended, mischievous, or malicious attacks that may occur to access sensitive (i.e., private, personal, or commercially valuable) information and data, which may include personal data (e.g., name, address, social security numbers, financial data including bank account and routing numbers, credit card numbers, billing addresses), business or commercial data (e.g., trade secrets, confidential business information, sales data), and other data and information which may be intercepted and used for unauthorized or malicious purposes, often harming the original or genuine user due to identity theft, business disparagement, financial losses, and credit history damage, among other things.

### SUMMARY

An embodiment is directed to a computer-implemented method for analyzing conversations. The method may include capturing a conversation with a microphone. The conversation may comprise a plurality of utterances. The method may also include converting the plurality of utterances into text data using speech recognition algorithms. A speaker may be identified and associated for each of the plurality of utterances. The method may further include determining an intent of the conversation. In addition, the method may include, for each determined intent, classifying each of the plurality of utterances based on the associated speaker and a set of categories associated with each of the plurality of utterances. The method may also include determining whether each of the plurality of utterances includes information sensitive to the associated speaker. Finally, the method may include storing the utterance in response to an utterance within the plurality of utterances not including information sensitive to the associated speaker.

In an embodiment, storing the utterance may include generating one or more search parameters based on the classifications of the plurality of utterances. Storing the utterance may also include performing a search of one or more servers using the generated one or more search parameters. Finally, storing the utterance may include displaying a list of search results at an edge device.

In another embodiment, classifying each of the plurality of utterances based on the associated speaker and a set of categories associated with each of the plurality of utterances may include using a machine learning classification model to predict whether an utterance includes information sensitive to the associated speaker.

In a further embodiment, the method may include transmitting the text data to the associated speaker. The method may also include monitoring an interaction of the associated speaker with the text data. Finally, the method may include updating whether an utterance includes information sensitive to the associated speaker based on the interactions.

In yet another embodiment, classifying each of the plurality of utterances based on the associated speaker and a set of categories may include generating an information tree, where the intent may be the root of the information tree, a node at a next lower level of the information tree may correspond to a speaker identified for at least one utterance and a node at a further next lower level of the information tree may correspond to each category used in classifying each of the plurality of utterances.

In addition to a computer-implemented method, additional embodiments are directed to a computer system and a computer program product for analyzing conversations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts an example of a system providing advanced services from an edge or cloud server to a user at the edge according to an embodiment.

FIG. 3 depicts a flow chart diagram of a process for monitoring and analyzing a conversation while protecting sensitive information in accordance with one or more embodiments.

FIG. 4 depicts an example classification of utterances within a conversation according to an embodiment.

FIG. 5 depicts a cloud computing environment according to an embodiment.

FIG. 6 depicts abstraction model layers according to an embodiment.

### DETAILED DESCRIPTION

The edge computing model is a distributed computing framework in which information processing may be located by service providers close to the network edge, where that information is produced or consumed. Edge computing may bring computation and data storage closer to the devices where the data is being gathered, rather than relying on a central location that can be thousands of miles away, resulting in a more decentralized environment.

Edge devices tend to generate enormous amounts of data during the course of their operations. Edge computing hardware and services are a local source of processing and storage for many of these systems. An edge server, for example, may process data from an edge device, and then send only the relevant data back through the cloud, reducing bandwidth needs, or it may send data back to the edge device in the case of real-time application needs. These edge devices may include many different things, such as a smart thermostat, an employee's notebook computer or smartphone, a security camera or an internet-connected microwave oven in the office break room. Edge servers themselves may be considered edge devices within the edge computing infrastructure.

In parallel with the rise of edge computing, until recently, voice recognition has mainly been used to listen and understand the voice of a user in local environments only without a connection to a server, with the intent to operate a nearby device or perform simple commands, e.g., adjusting sound volume in a vehicle or volume control and channel selection on a television using a remote control with voice recognition features.

It is now common to use voice recognition to monitor the sound in the environment for a trigger word, e.g., “Hey Siri!” or “Alexa!” or “Watson!”, and, once the trigger is recognized, perform more intelligent and advanced services for users, e.g., searching and purchasing a specific product or analyzing driving conditions and assisting in route selection, based on specific preferences. These services may be accessed through a local server that supports voice recognition and may work with a remote server to fulfill the request. As an example, a user may ask a question about the best restaurant with a certain type of food in the city, or perhaps the closest restaurant or hotel to a current location. To fulfill this request, the user's voice may be captured, and the request analyzed locally but the local server may then refer to a server in the cloud and check against a central database of restaurants or hotels or whatever was requested.

Further improvements to service provision and voice recognition, as anticipated by advances in automatic speech recognition (ASR) and natural language processing (NLP) algorithms, may include the ability for the edge device to actively listen to a conversation that is taking place and react as it hears specific words. In such an instance, it becomes more paramount to protect a user's sensitive information from being compromised and it may be necessary to ignore or block the transmission of the sensitive personal information that may specifically identify a user and leave them open to possible information security attacks. Information that may be sensitive to someone speaking in a conversation may include personal data (e.g., name, address, social security numbers, financial data including bank account and routing numbers, credit card numbers, billing addresses), business or commercial data (e.g., trade secrets, confidential business information, sales data), and other data and information which may be intercepted and used for unauthorized or malicious purposes, often harming the original or genuine user due to identity theft, business disparagement, financial losses, and credit history damage, among other things.

Disclosed herein is a method to capture and analyze the underlying information that is available from spoken audio in a standard conversation environment, e.g., in a vehicle or on the street or a room in a residential or commercial setting, but prevent sensitive information, as defined by the speaker of that information, from being disseminated or even stored such that it could be compromised. It also should be noted that monitoring user conversations (e.g, using a microphone in an “always-listening” mode) as used herein requires the informed consent of all people whose conversations are captured for analysis. Consent may be obtained in real time or through a prior waiver or other process that informs a subject that their voice will be captured by a microphone and that the audio will be analyzed by a speech recognition algorithm and natural language processing.

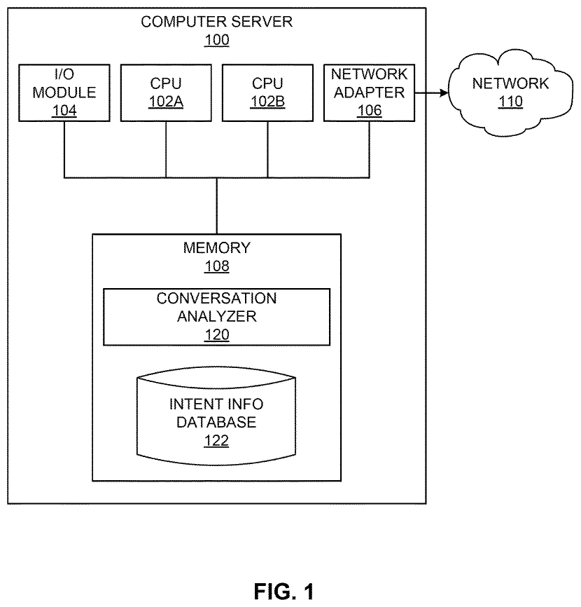

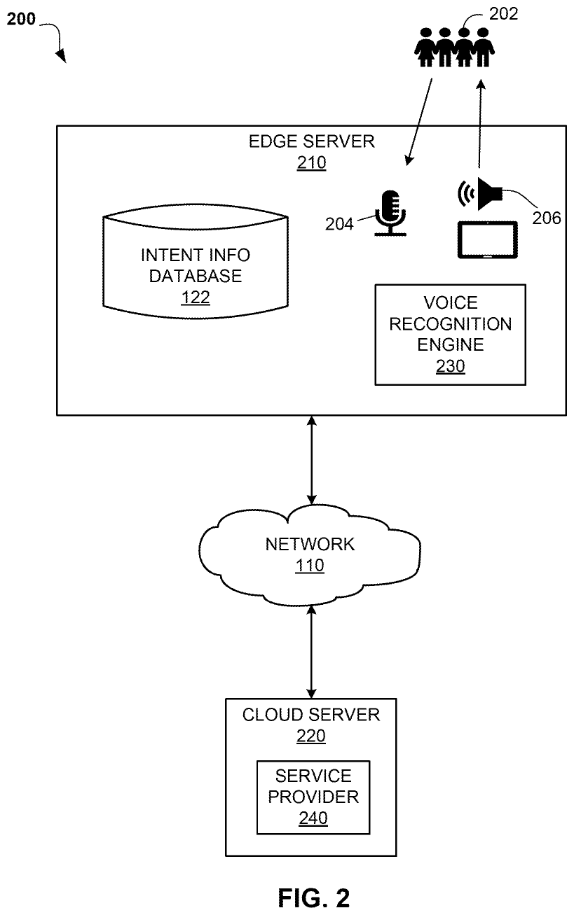

Referring to FIG. 1, a block diagram of a computer server 100, in which processes involved in the embodiments described herein may be implemented, is shown. Computer server 100 represents computer hardware, e.g., edge server 210 in FIG. 2, that runs the software described in the embodiments. Computer server 100 may include one or more processors (CPUs) 102A-B, input/output circuitry 104, network adapter 106 and memory 108. CPUs 102A-B execute program instructions in order to carry out the functions of the present communications systems and methods. FIG. 1 illustrates an embodiment in which computer server 100 is implemented as a single multi-processor computer system, in which multiple processors 102A-B share system resources, such as memory 108, input/output circuitry 104, and network adapter 106. However, the present communications systems and methods also include embodiments in which computer server 100 is implemented as a plurality of networked computer systems, which may be single-processor computer systems, multi-processor computer systems, or a mix thereof. Input/output circuitry 104 provides the capability to input data to, or output data from, computer server 100. Network adapter 106 interfaces computer server 100 with a network 110, which may be any public or proprietary LAN or WAN, including, but not limited to the Internet.

Memory 108 stores program instructions that are executed by, and data that are used and processed by, CPU 102A-B to perform the functions of computer server 100. Memory 108 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an Integrated Drive Electronics (IDE) interface, or a variation or enhancement thereof, such as enhanced IDE (EIDE) or Ultra-Direct Memory Access (UDMA), or a Small Computer System Interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a Fibre Channel-Arbitrated Loop (FC-AL) interface.

The contents of memory 108 may vary depending upon the function that computer server 100 is programmed to perform. In the example shown in FIG. 1, example memory contents are shown representing routines and data for embodiments of the processes described herein. However, it may be recognized that these routines, along with the memory contents related to those routines, may not be included on one system or device, but rather may be distributed among a plurality of systems or devices, based on well-known engineering considerations. The present communications systems and methods may include any and all such arrangements.

Included within memory 108 is the conversation analyzer 120 which may run the routines that are described in the embodiments below. In order to store information that may be relevant to an intent of a conversation and also to the determining of that intent, the conversation analyzer 120 may access an intent information database 122 that may store any non-sensitive information as described below. Also, as the conversation analyzer 120 interacts with new captured audio and subsequent related text data, it may update the intent information database 122 to include the information that it determines is relevant and non-sensitive. The intent information database 122 may be in any form that holds necessary information about the intent of a conversation, including classified utterances, as described below, or other relevant and non-sensitive information. The filtering decisions for information within an utterance, i.e., whether information is to be considered sensitive, that may be made by the speaker, or owner, of such information may also be stored in the intent information database 122.

Referring to FIG. 2, an example 200 of monitoring a conversation while protecting sensitive information is shown according to an embodiment. A conversation 202 may be taking place in any closed space, e.g., the cabin of an automobile or a room in a residential or commercial building, or any open space such as on the street while walking. A microphone 204, fixed or non-fixed, may be placed nearby to capture the voices participating in the conversation. In an embodiment, the microphone 204 may be in an “always-listening” mode, such that no trigger is required to begin audio capture and/or recording. The microphone 204 may also, at the option of the user, be switched out of an “always-listening” mode (e.g., have the “always-listening” mode turned off).

In the embodiment shown in FIG. 2, the microphone 204 is embedded within an edge server 210, which may be a car navigation device, configured to control a plurality of in-vehicle devices such as cameras and microphones in an integrated manner and communicate with a cloud server 220 via a network 110. Another example of a local environment may be a factory with many machine tools in addition to other devices located in it. However, this integration is not required. It is not necessary for there to be many devices under control but rather that there be a mechanism for accepting voice input from a conversation. Examples of nearby microphones include a microphone 204 mounted in a room or along the street or embedded in a smartphone or other mobile device that is carried by one of the speakers. One of ordinary skill in the art would appreciate that one or more microphones may be arranged in multiple ways to capture a conversation. It may also be understood that the edge server 210 and microphone 204 may be separate devices or may be functions that are combined into a single device or multiple devices.

A local voice recognition engine 230 may also be included within the edge server 210 to process the audio data that has been captured and convert the audio data to text using automatic speech recognition (ASR) algorithms, as well as use natural language processing algorithms to recognize the meaning of an utterance such that an intent of a conversation may be determined. This engine 230 may also identify the speaker of the voice data by analyzing tone of speech, voice print or voice quality and comparing to a database. This list of possible methods for determining speaker identity is not intended to be exhaustive and one of ordinary skill in the art will appreciate that there are many ways to identify speakers. It is also understood that identifying the speaker is not required to be done by the engine 230 but may be done in any component of the system that has the capability. Only the engine 230 is shown in FIG. 2 for simplicity.

To provide relevant services, it may be necessary, but it is not required, that an edge server refer to a service provider 240 on a cloud server 220 via a network 110. The service provider 240 may manage the connection between the edge server 210 and cloud server 220. As described below, only non-sensitive information may be transmitted between the edge server 210 and cloud server 220. As examples, the service provider 240 may be a web service that provides recommendations for hotels or restaurants or other retail services and once an intent of a conversation is known, the appropriate service provider 240 may be selected and search results may be transmitted back to the edge server 210 and eventually back to the speakers in the conversation 202 via an edge device 206 such as audio speakers or a smartphone or other mobile device. It is not required that the input device, e.g., microphone 204, and the output device, e.g., edge device 206, be embedded in the same device as shown in FIG. 2.

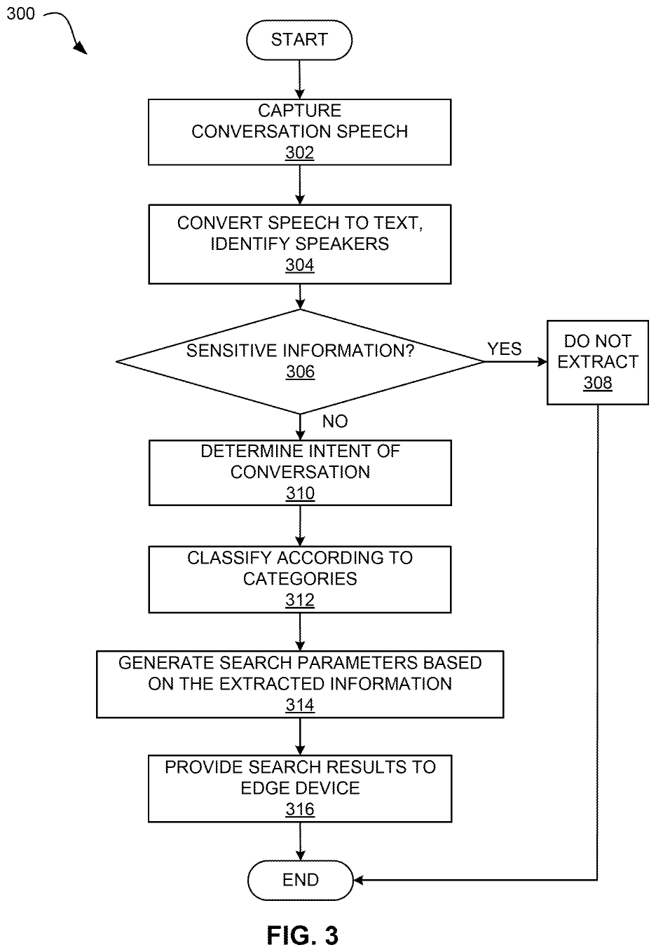

Referring to FIG. 3, an operational flowchart illustrating a process 300 for monitoring and analyzing a conversation while protecting sensitive information is depicted according to at least one embodiment. At 302, a voice-enabled edge device such as microphone 204 may be used to capture spoken audio that is in proximity to the device. For example, a group of people may be walking together on the street or riding together in an automobile and talking about arranging an event or simply arranging a meal together. A smartphone being carried by one of the speakers may be set to actively capture any conversation in its proximity and process the audio it captures. If the conversation is occurring in an automobile, a microphone connected to a vehicle control system may capture the audio. One of ordinary skill in the art will understand that conversations occur in many environments and microphones may be placed in different ways that are appropriate to that environment. As mentioned with respect to the edge server 210, the device that captures the audio may also process the audio and communicate with a cloud server but it is not required that all these steps occur in one device at the furthest edge of the network. The audio that is captured at this step may be stored to allow for a processing buffer at the conversion step.

At 304, the captured audio data may be converted from speech to text and the speaker of each utterance may be identified. The conversion from speech to text may be accomplished using automatic speech recognition (ASR), or speech to text (STT), algorithms within the voice recognition engine 230.

The voice recognition engine 230 may process the captured audio data with reference to stored information or alternatively, processed data may be received by the voice recognition engine 230 from another source. For example, the edge device may process audio data into feature vectors and transmit that information to a cloud server across a network for ASR processing. Feature vectors may arrive encoded, in which case they may be decoded prior to processing by the voice recognition engine 230.

The voice recognition engine 230 may attempt to match its input to language phonemes and words as known in stored acoustic models or language models. The voice recognition engine 230 may compute recognition scores for the data based on acoustic information and language information. The acoustic information may be used to calculate an acoustic score representing a likelihood that the intended sound represented by a group of feature vectors within the input data matches a language phoneme. The language information may be used to adjust the acoustic score by considering what sounds and/or words are used in context with each other, thereby improving the likelihood that the ASR process will output text data that makes sense grammatically. The specific models used may be general models or may be models corresponding to a particular topic, e.g., food, music or banking, etc. Audio data corresponding to the user utterance may be sent to the voice recognition engine 230, which may identify, determine, and/or generate text data corresponding to the utterance. The voice recognition engine 230 may use a number of techniques to match feature vectors to phonemes, for example using Hidden Markov Models (HMMs) to determine probabilities that feature vectors may match phonemes. Sounds received may be represented as paths between states of the HMM and multiple paths may represent multiple possible text matches for the same sound.

Also at this step, the speaker of a given utterance may be identified using speaker recognition algorithms that analyze tone of speech, voice print or voice quality and compare to a database, as described above.

At 306, it may be determined whether information in the conversation is considered to be sensitive. This may be accomplished by classifying information within each utterance as sensitive or not. Sensitive information may be filtered from extraction or logging at the local edge and therefore prevented from being retained or sent to a remote server, which is step 308. Information classified as not sensitive may be forwarded to step 310 for further processing.

The decisions for filtering content may be set by an owner of sensitive information or with training data that is put into the classification model. The filter, or the ability to mark information as sensitive or not sensitive with respect to the machine learning classifier, may be configured for the information to be transmitted to the cloud server or may be configured for each piece of the intent information. In an initial state, transmission of all pieces of information may be disabled and only logging of information may be performed, such that no information may be sent to the cloud server. This default initial setting means the owner of the potentially sensitive information is required to consent to any information being retained or transmitted over a network.

The information owner may check the logged information via a user interface (UI) provided at the edge server or via a mobile device such as a smartphone or tablet and confirm what information may be transmitted to the cloud server, and therefore what information may be classified as sensitive. The information owner may also test what services may be received by disclosing that information by selecting logged text data and transmitting that data to the cloud server to decide whether to approve transmission of certain information, or manually mark that information according to sensitivity. If the information owner approves transmission via these filter settings, only the information that is approved may be transmitted to the cloud server. Any sensitive information will still be classified as such and blocked from retention or transmission.

It should be noted that the information owner is free to make these decisions at any time and change what they choose to be sensitive information as these settings are permanently retained to keep the machine learning classifier updated with the latest information and also allow the owner of the information complete control over their informed consent to use sensitive information to retrieve advanced services.

To make decisions on the audio that is captured in real time with respect to sensitivity in step 306 or intent of a conversation as discussed in step 310 or classifying utterances into specific categories as discussed in step 312, natural language processing (NLP) algorithms may be used on the text data that comes from the speech to text conversion. Generally, the NLP process takes textual input (such as the output of the ASR process described above based on the utterance input audio) and attempts to make a semantic interpretation of the text. That is, the NLP process determines the meaning behind the text based on the individual words and then implements that meaning. In the context of step 306, if a spoken utterance is processed using ASR as described above and results in the text “my credit card number is 1234”, an NLP algorithm may determine that credit card numbers are sensitive information and classify the information as sensitive.

At 310, the intent of the conversation may be determined by analyzing the text data corresponding to the conversation using NLP algorithms, taking care to only extract non-sensitive intent information as determined in step 306. NLP processing interprets a text string to derive an intent or a desired action from the user as well as the pertinent pieces of information in the text that allow a device to complete that action. For example, if a spoken utterance is processed using ASR as described above and results in the text “I am hungry”, an NLP algorithm may determine that the speaker intended to receive information associated with restaurants or other food establishments that are local and potentially searchable by a service. The intent may be stored to the intent information database 122. The machine learning model may look to specific instances within its training data or specifically to other conversations that had the same or similar intent and use that data to classify certain utterances into the proper category in the context of the conversation. It should be understood that many utterances may have different meanings in various conversations with separate intents. Therefore, the specificity of intent may be needed to sort through the available training data to classify the utterance properly.

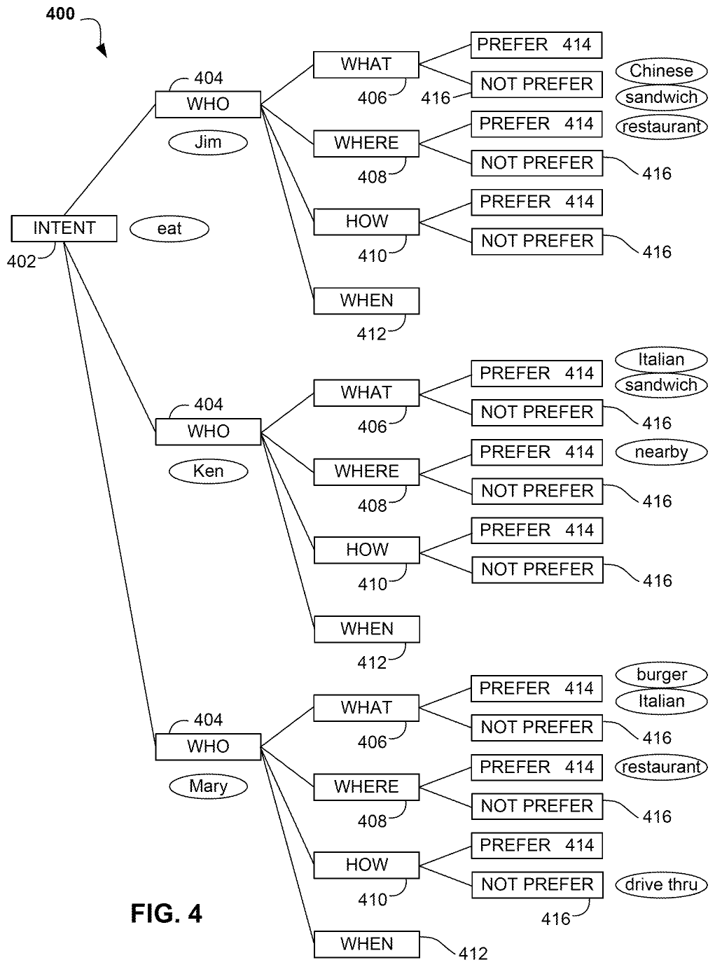

At 312, the utterances in a conversation, having been converted to text data, may be classified according to a set of categories using a machine learning classification model. One or more of the following machine learning algorithms may be used to classify the events: logistic regression, naive Bayes, support vector machines, artificial neural networks, random forecasts and random forests. In an embodiment, an ensemble learning technique is employed that uses multiple machine learning algorithms together to assure better prediction when compared with the prediction of a single machine learning algorithm. Each category used in the classification may be equivalent to a characteristic of the utterance or a question that may be answered by the utterance. For example, a category may be “when”, seeking a time that something related to the intent of the conversation may happen. In this example, an utterance of “right now” or “sometime soon” may answer the question and therefore may be classified in this category. Details of the categories and an example classification are discussed in FIG. 4.

At 314, search parameters may be generated using the information that has been classified as both not sensitive and according to the categories that correspond to the intent of the conversation. These search parameters may be used to search a variety of local or cloud-base services that may be available to the speakers in the conversation through the edge devices in proximity to the conversation. As an example of the services available that may be searched, it may be desirable to search nearby restaurants based on reputation and the menu, as well as whether reservations are needed or available, each of which may be targeted based on the categories that have been used to classify the utterances. In addition, if the speaker of the utterance is known, a service may recommend the menu based on that speaker's browsing history or social media information. Even if the speaker of the utterance is not known, a general recommendation may be made according to the time of conversation or simply based on the menu of a restaurant.

Another example may be that a user intends to purchase ingredients for a meal. Using information about what a speaker wants to make, a cloud service could search a nearby store, compare prices of the ingredients, including any current special deals, and may also determine current availability of parking, as well as other attributes depending on the information that is extracted from the conversation and classified in the various categories. In this example, if the speaker is known, it may be possible to see what ingredients are already in their refrigerator and recommend the purchase of any missing materials. If the speaker is not known, a cloud service may be able to refine its recommendation based on what is classified in the “prefer” or “not prefer” categories over the course of the conversation. In the absence of more specific information, the server could just recommend any ingredients that are on sale.

At 316, the search results may be provided to the edge device and displayed on the screen. These search results may be ordered in the display based on a ranking or relevancy score that has been determined by the service or some other method to anticipate the intent of the conversation and provide relevant results.

Referring now to FIG. 4, an example of the classification of the plurality of utterances that are contained in a conversation is shown according to an embodiment. For the purposes of this example of the classification process and categories, the following sample conversation may be used.
Jim: “I am hungry”
Ken: “Me too. Let's have lunch around here. What do you want to have?”
Jim: “I don't feel like having Chinese food today”
Ken: “I want to have Italian food”
Mary: “I want to have a hamburger”
Ken: “A sandwich is OK”
Jim: “I had a sandwich this morning, so I prefer something else”
Mary: “Ok, then Italian food or a burger. Watson, what is your recommendation?”
Jim: “Oh, there is a cute dog over there.”
Mary: “Yes, it's cute! . . . should we drive through or sit down?”
Jim: “I want to take a break for a while. I have been driving for two hours!”
Mary: “OK. So, let's sit down instead of driving through and take a break.”

In this example, the categories may be arranged in a tree structure where the intent 402 of the conversation is at the root. Using the sample conversation above, the intent “eat”, e.g., arranging to have a meal, may be extracted from the conversation. The nodes 404 at the next level labeled as “who” may represent each speaker. In the sample conversation, three speakers, “Jim”, “Ken” and “Mary”, may be identified in the conversation. It should be noted that FIG. 4 shows the three speakers from the example conversation above but there may be any number of speakers in a conversation that may be captured. In addition, while the label used in FIG. 4 is “who”, the labels for these nodes, and for all nodes in the tree structure that is depicted, need not be the exact labels that are shown. What is important is that the utterances are classified into categories that are recognized as certain types of information that may facilitate a proper understanding of the conversation.

Once the intent of the conversation is established and the speakers in the conversation are identified, the remaining categories may begin to be populated as necessary with utterances from the conversation as they are classified by the model. In the example shown in FIG. 4, the categories at the next level of the tree are “what” 406, shown in the example conversation as “Chinese” or “Italian” or “burger” and may include what type of food is desired, “where” 408, shown in the example conversation as a colloquial term “nearby”, e.g., “around here”, but may also include a geographical location depending on the context of the conversation, “how” 410, which in the example conversation may include “drive through” or “sit down” as how the speakers wish to accomplish the task of having a meal, and “when” 412, which may be immediate or any time frame that may be extracted from the conversation.

The utterances may be separated within each category, as depicted in FIG. 4 with the additional level of “prefer” 414 and “not prefer” 416. This separation may indicate whether or not the speaker prefers the information that is being classified. As an example, in the sample conversation, “Ken” has indicated separately that “I would like Italian food” and “A sandwich is OK” so both “Italian” and “sandwich” may be classified as “prefer” 414 under “what” 406. Each utterance in a conversation may be classified in this way and stored according to the classification.

It should be noted that the tree structure shown in FIG. 4 is only an example of how to depict the classification of the utterances within a conversation. One of ordinary skill in the art will recognize that several methods may be used to arrange the utterances and retaining the text data of a captured conversation in various classifications to assist in the decision of what services to provide to users at the edge of the network.

As mentioned previously, there is no specific order that the utterances from the conversation must be classified. While the sample conversation above and FIG. 4 show a specific configuration, one of ordinary skill in the art may recognize that the categories may appear in any order at a given level of the tree structure shown and extraction may occur in any order. The only restriction is that the intent 402 and identity of the speakers, e.g., “who” 404, must be known before the remaining nodes in the tree may be populated. It is also not necessary for every one of these categories to be present for a given conversation. Not all the information that is shown in the sample conversation and FIG. 4, or more information, may be present in an actual conversation and only what is present in a conversation may be populated in the tree.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

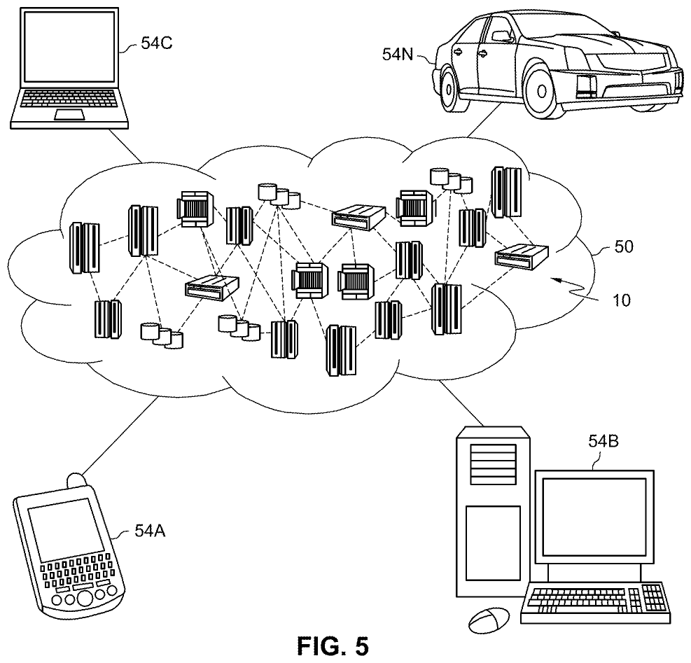

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

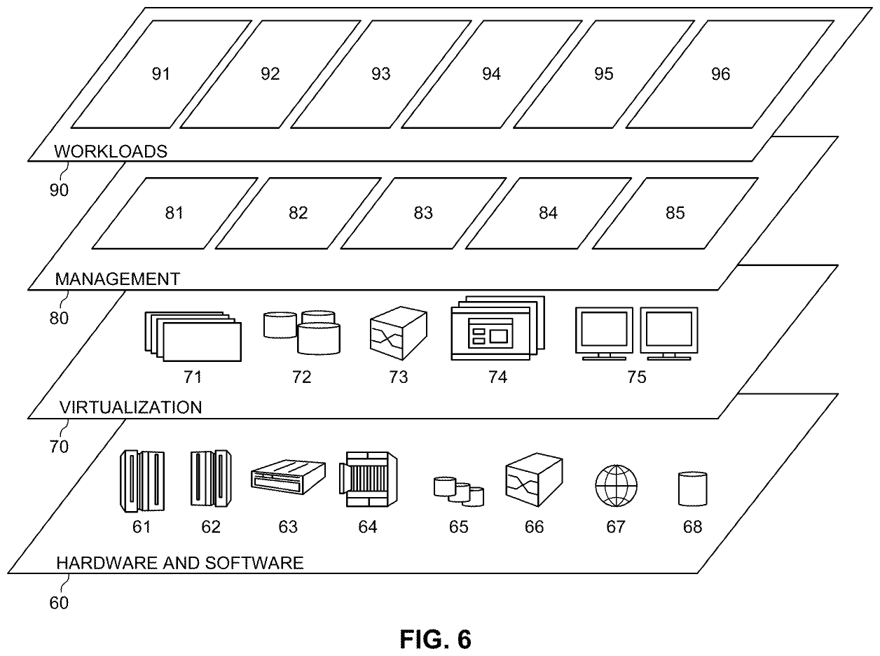

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and other applications 96 such as software that analyzes nearby conversations to protect sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for analyzing conversations, comprising:
capturing a conversation with a microphone, wherein the conversation comprises a plurality of utterances;
converting the plurality of utterances into text data using speech recognition algorithms, wherein a speaker is identified and associated for each of the plurality of utterances;
determining an intent of the conversation;
for each determined intent, classifying each of the plurality of utterances based on the associated speaker and a set of categories associated with each of the plurality of utterances;
determining whether each of the plurality of utterances includes information sensitive to the associated speaker; and
in response to an utterance within the plurality of utterances not including information sensitive to the associated speaker, storing the utterance.

2. The computer-implemented method of claim 1, wherein storing the utterance further comprises:
generating one or more search parameters based on the classifications of the plurality of utterances;
performing a search of one or more servers using the generated one or more search parameters; and
displaying a list of search results at an edge device.

3. The computer-implemented method of claim 1, wherein the classifying each of the plurality of utterances further comprises using a machine learning classification model to predict whether the utterance includes information sensitive to the speaker.

4. The computer-implemented method of claim 1, further comprising:
transmitting the text data to the associated speaker;
receiving a determination from the associated speaker whether an utterance within the text data includes information sensitive to the associated speaker; and
updating whether the utterance includes information sensitive to the associated speaker based on the determination.

5. The computer-implemented method of claim 1, wherein classifying each of the plurality of utterances further comprises generating an information tree, wherein the intent is the root of the information tree.

6. The computer-implemented method of claim 5, wherein a node at a next lower level of the information tree corresponds to a speaker identified for at least one utterance.

7. The computer-implemented method of claim 6, wherein a node at the next lower level of the information tree corresponds to each category used in classifying each of the plurality of utterances.

8. A computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
capturing a conversation with a microphone, wherein the conversation comprises a plurality of utterances;
converting the plurality of utterances into text data using speech recognition algorithms, wherein a speaker is identified and associated for each of the plurality of utterances;
determining an intent of the conversation;
for each determined intent, classifying each of the plurality of utterances based on the associated speaker and a set of categories associated with each of the plurality of utterances;
determining whether each of the plurality of utterances includes information sensitive to the associated speaker; and
in response to an utterance within the plurality of utterances not including information sensitive to the associated speaker, storing the utterance.

9. The computer system of claim 8, wherein storing the utterance further comprises:
generating one or more search parameters based on the classifications of the plurality of utterances;
performing a search of one or more servers using the generated one or more search parameters; and
displaying a list of search results at an edge device.

10. The computer system of claim 8, wherein the classifying each of the plurality of utterances further comprises using a machine learning classification model to predict whether the utterance includes information sensitive to the speaker.

11. The computer system of claim 8, further comprising:
transmitting the text data to the associated speaker;
monitoring an interaction of the associated speaker with the text data; and
updating whether the utterance includes information sensitive to the associated speaker based on the interactions.

12. The computer system of claim 8, wherein classifying each of the plurality of utterances further comprises generating an information tree, wherein the intent is the root of the information tree.

13. The computer system of claim 12, wherein a node at a next lower level of the information tree corresponds to a speaker identified for at least one utterance.

14. The computer system of claim 13, wherein a node at the next lower level of the information tree corresponds to each category used in classifying each of the plurality of utterances.

15. A computer program product comprising:
a computer readable storage device storing computer readable program code embodied therewith, the computer readable program code comprising program code executable by a computer to perform a method comprising:
capturing a conversation with a microphone, wherein the conversation comprises a plurality of utterances;
converting the plurality of utterances into text data using speech recognition algorithms, wherein a speaker is identified and associated for each of the plurality of utterances;
determining an intent of the conversation;
for each determined intent, classifying each of the plurality of utterances based on the associated speaker and a set of categories associated with each of the plurality of utterances;
determining whether each of the plurality of utterances includes information sensitive to the associated speaker; and
in response to an utterance within the plurality of utterances not including information sensitive to the associated speaker, storing the utterance.

16. The computer program product of claim 15, wherein storing the utterance further comprises:
generating one or more search parameters based on the classifications of the plurality of utterances;
performing a search of one or more servers using the generated one or more search parameters; and
displaying a list of search results at an edge device.

17. The computer program product of claim 15, wherein the classifying each of the plurality of utterances further comprises using a machine learning classification model to predict whether the utterance includes information sensitive to the speaker.

18. The computer program product of claim 15, further comprising:
transmitting the text data to the associated speaker;
monitoring an interaction of the associated speaker with the text data; and
updating whether the utterance includes information sensitive to the associated speaker based on the interactions.

19. The computer program product of claim 15, wherein classifying each of the plurality of utterances further comprises generating an information tree, wherein the intent is the root of the information tree.

20. The computer program product of claim 19, wherein a node at a next lower level of the information tree corresponds to a speaker identified for at least one utterance.
